(19) United States
(12) Patent Application Publication
(10) Pub. No.: US 2007/0133585 A1
(43) Pub. Date: Jun. 14, 2007

(54) Method and device for scheduling interconnections in an interconnecting fabric

(75) Inventors: Cyriel Johan Agnes Minkenberg, Adliswil (CH); Francois Abel, Rueschlikon (CH); Enrico Schiattarella, Vercelli (IT); Venkatesh Ramaswamy, Los Alamos, NM (US)

Correspondence Address: IBM CORPORATION, T.J. WATSON RESEARCH CENTER, P.O. BOX 218, YORKTOWN HEIGHTS, NY, 10598, US

(73) Assignee: International Business Machines Corporation, Armonk, NY (US)

(21) Appl. No.: 11/297,618

(22) Filed: Dec. 8, 2005

(51) Int. Cl. H04L 12/56; H04L 12/28

(52) U.S. Cl. 370/420; 370/395.4

(57) ABSTRACT

The method for scheduling interconnections in an interconnecting fabric comprises the following steps. In a determined time slot input selectors generate requests using a request pointer set, which is related to the determined time slot. Then, the requests are transmitted to output selectors, and the output selectors issue grants using a grant pointer set, which is also related to the determined time slot. In a further step the grants are transmitted to the input selectors, and the input selectors update the request pointer set. These steps are repeated, wherein for a further time slot a further request and grant pointer set are used, which are related to the further time slot.

This invention was made with Government support under Contract No. B527064 awarded by the Department of Energy. The Government has certain rights in this invention.

### TECHNICAL FIELD

The present invention relates to a method and a device for scheduling interconnections in an interconnecting fabric.

### BACKGROUND OF THE INVENTION

Allocators for packet switches with unbuffered crossbars typically employ iterative bipartite graph matching algorithms, e.g. iSLIP, FIRM and DRRM. In the implementation of a matching algorithm, as it is known from of P. Gupta and N. McKeown, “Designing and implementing a fast crossbar scheduler,” IEEE Micro Magazine, vol. 19, no. 1, January-February 1999, pp. 20-28, it is assumed that all input and output selectors and the corresponding registers are all located on a single chip. As a chip is limited in terms of I/O bandwidth, pin count, wiring and number of gates, this assumption translates to a limit on the number of ports that can be arbitrated.

### SUMMARY OF THE INVENTION

An object of the invention is to provide a method and a device for scheduling interconnections in an interconnecting fabric, which enable effective distributed implementations of multiphase scheduling algorithms. The invention aims at high performance, regardless of how the input and the output selectors are physically distributed and how long the latency between them is. The invention also aims at fairness in the presence of significant delay between input and output selectors. An advantage of the invention is that the scheduling device is scalable. This means that with the invention a large number of ports can be arbitrated, while the impact on throughput, latency, and complexity is optimized.

According to one aspect of the invention, the object is achieved by a method for scheduling interconnections in an interconnecting fabric with the features of the independent claims 1 and 4.

A first method for scheduling interconnections in an interconnecting fabric according to the invention comprises the following steps. In a determined time slot input selectors generate requests using a request pointer set that is related to the determined time slot. Then, the requests are transmitted to output selectors, and the output selectors generate grants using a grant pointer set that is also related to the determined time slot and the output selectors update the grant pointer set. In a further step the grants are transmitted to the input selectors, and the input selectors update the request pointer set. These steps are repeated, wherein for a further time slot a further request and grant pointer set are used, which are related to the further time slot.

A second method for scheduling interconnections in an interconnecting fabric according to the invention comprises the following steps. In a first time slot input selectors generate requests for interconnections using a first request pointer set, which is updated at the end of the round trip time for a request-grant cycle. In a further time slot input selectors generate requests for interconnections using a second request pointer set, which is updated before a succeeding time slot.

According to another aspect of the invention, the object is achieved by an input selector device for scheduling interconnections in an interconnecting fabric with the features of the independent claim 12 and an output selector device for scheduling interconnections in an interconnecting fabric with the features of the independent claim 13.

An input selector device for scheduling interconnections in an interconnecting fabric according to the invention comprises registers for request pointers, a selection unit, which is operable to select one of the registers and generate requests for interconnections, and an output terminal which is coupled to the selection unit and at which a signal representing the request can be tapped.

An output selector device for scheduling interconnections in an interconnecting fabric according to the invention comprises output selectors, wherein each output selector comprises registers for grant pointers, input terminals operable to receive requests from an input selector device, and output terminals operable to transmit grants to the selector device.

Advantageous further developments of the invention arise from the characteristics indicated in the dependent patent claims.

Preferably, in the method according to the invention the round trip time, which is the time period for a request-grant cycle, is divided into a determined number of time slots, and a separate pointer set is related to every time slot.

In an embodiment of the method according to the invention the pointer set is updated at the end of the round trip time.

A system for scheduling interconnections in an interconnecting fabric according to the invention comprises one or more of the above mentioned input selector devices and the above mentioned output selector device, which is connected to the input selector devices, wherein the input selector devices and the output selector device are operable to control a crossbar switch.

In a further embodiment of the method according to the invention the output selectors issue grants using a first grant pointer set, if the received requests were generated using the first request pointer set, and the output selectors issue grants using a second grant pointer set, if the received requests were generated using the second request pointer set.

Finally, in the method according to the invention the output selectors can update the first grant pointer set before they receive the next requests, and the output selectors can update the second grant pointer set before they receive the next requests.

### BRIEF DESCRIPTION OF THE DRAWINGS

The invention and its embodiments will be more fully appreciated by reference to the following detailed description of presently preferred but nonetheless illustrative embodiments in accordance with the present invention when taken in conjunction with the accompanying drawings.

The figures are illustrating:

FIG. 1 a block diagram of an input-queued switch for a computer network with a centralized scheduler,

FIG. 2a a block diagram of an i-SLIP scheduler,

FIG. 2b a block diagram of a DRRM scheduler,

FIG. 3a the first iteration of a dual round robin matching,

FIG. 3b the second iteration of the dual round robin matching,

FIG. 3c the third iteration of the dual round robin matching,

FIG. 3d the final matching,

FIG. 4 an example for a request and grant timing according to a first method for scheduling interconnections,

FIG. 5 an example for a request and grant timing according to a second method for scheduling interconnections,

FIG. 6a a flow diagram of the scheduling algorithm running on each input selector, according to the first method for scheduling interconnections,

FIG. 6b a flow diagram of the scheduling algorithm running on each input selector, according to the second method for scheduling interconnections,

FIG. 7 a flow diagram of the scheduling algorithm running on each output selector, according to the first method for scheduling interconnections,

FIG. 7 a flow diagram of the scheduling algorithm running on each output selector, according to the second method for scheduling interconnections,

FIG. 8 a flow diagram of the request policy algorithm,

FIG. 9 a block diagram of an embodiment of the centralized scheduler with input and output selectors, and

FIG. 10 a block diagram of an embodiment of a request generating part of an input selector.

### DETAILED DESCRIPTION OF THE DRAWINGS

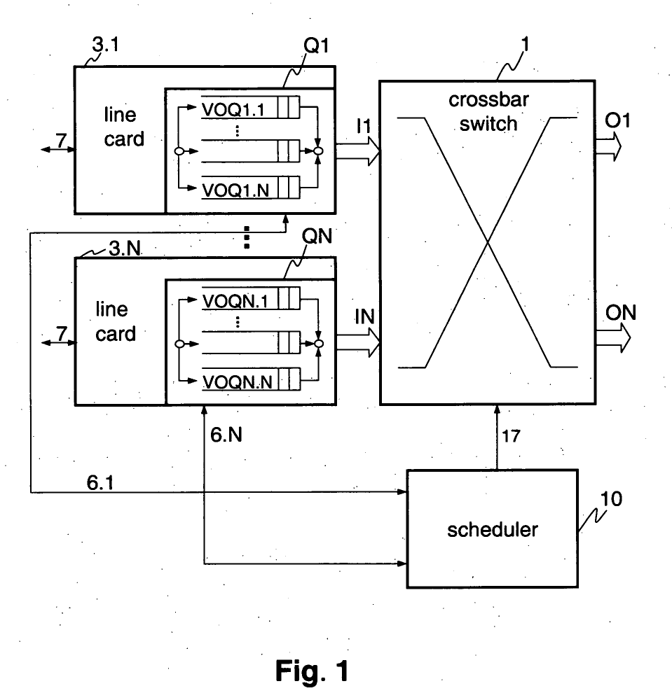

The switching device according to FIG. 1 is based on an input-queued architecture comprising a number N of line cards 3.1 to 3.N, a crossbar switch 1, having N inputs I1 to IN and N outputs O1 to ON, and a centralized scheduler or arbitration unit 10. The line cards 3.1 to 3.N form the interfaces between the switch and its environment, and receive packets on input links 7 and transmit packets to the inputs I1 to IN of the crossbar 1. The line cards 3.1 to 3.N also keep queues Q1 to QN of incoming packets waiting to be transmitted to the outputs O1 to ON, which are also called output ports. Unicast packets arriving at a line card are stored in different virtual output queues (VOQs) depending on their destination. This means that at each input I of the crossbar switch 1, a separate first in first out (FIFO) queue is maintained for each output 0, as shown in FIG. 1. For example, the first input I1 of the crossbar switch 1 is coupled to N VOQs labelled VOQ1.1 to VOQ1.N, whereas the second input 12 of the crossbar switch 1 is coupled to N VOQs labelled VOQ2.1 to VOQ2.N. After a forwarding decision has been made, a cell arriving from one of the line cards 3.1 to 3.N is placed in the virtual output queue corresponding to its outgoing port.

The switching device works with time slots. That is, the time is divided in slots of equal duration, called time slots. The duration of a time slot is equal to the time it takes a fixed-size data unit called cell to be transmitted. Incoming data packets are segmented into cells at the inputs and reassembled at the outputs.

A crossbar switch is an interconnecting or switching fabric used to construct switches. Crossbar switches are sometimes referred to as cross-point switches. Crossbar switches have a characteristic matrix of switches between the inputs to the switch and the output of the switch. If the switch has M inputs and N outputs, then a crossbar has a matrix with M×N cross-points or places where the “bars” “cross”.

The crossbar switch 1 is a circuit capable of interconnecting the N inputs I1 to IN to the N outputs O1 to ON. At every time slot, the set of possible input-output connections is limited by the constraints that at most one packet can depart from each input I and at most one packet can arrive at each output O. However, a cell departing from an input I can be received by multiple outputs O. Hence, the crossbar switch 1 offers natural support for multicast traffic because it allows the replication of a packet to multiple outputs O in a single time slot.

The centralized scheduler 10 is connected via control channels 6.1 to 6.N to the line cards 3.1 to 3.N and via output 17 to the control inputs of crossbar switch 1. The centralized scheduler 10 examines the status of the virtual output queues VOQ1.1 to VOQN.N at every time slot and computes a configuration for the crossbar switch 1, subject to the constraints mentioned above. This operation is equivalent to finding a matching or schedule between nodes of a bipartite graph, in which each node represents an input or an output.

Finding a matching on a bipartite graph can be accomplished by means of a heuristic iterative algorithm such as iSLIP, which is further described in N. McKeown, “The iSLIP Scheduling Algorithm for Input-Queued Switches,” IEEE/ACM Trans. Networking, vol. 7, no. 2, April 1999, pp. 188-201, DRRM (Dual Round Robin Matching), which is further described in H. Chao and J. Park, “Centralized contention resolution schemes for a large-capacity optical ATM switch,” Proc. IEEE ATM Workshop, Fairfax, Va., May 1998, pp. 11-16, or FIRM (Fairness In Round Robin Matching), which is further described in D. N. Serpanos and P. I. Antoniadis, “FIRM: A class of distributed scheduling algorithms for high-speed ATM switches with multiple input queues,” Proc. INFOCOM 2000, Tel Aviv, Israel, March 2000, vol. 2, pp. 548-555).

The above mentioned algorithms offer among others the following advantages: First, the algorithms have high performance, and more precisely, they guarantee 100% throughput under uniform uncorrelated traffic with a single iteration. Secondly, fairness is ensured, i.e., the algorithms ensure that under any traffic pattern any non-empty VOQ, which represents an input-output pair, receives service within finite time. Thirdly, the algorithms are simple and fast. They use one selector per input, called input selector IS, and one selector per output, called output selector OS, which results in a total of 2N selectors. These selectors operate independently and in parallel and are relatively simple to implement in fast hardware.

These algorithms are used to compute a matching in every time slot in a sequence of iterations. They can be classified as two-phase or three-phase, depending on how many iteration steps each iteration entails. In principle, they work as follows.

In a two-phase algorithm the following iteration steps are performed in every iteration, wherein initially all inputs and outputs are unmatched:
Iteration step 1: Each unmatched input requests one unmatched output for which it has queued packets.
Iteration step 2: Each output grants one of the requesting inputs, if any.

The two iteration steps are repeated until the desired number of iterations has been reached.

In a three-phase algorithm, for example iSLIP, the following iteration steps are performed in every iteration, wherein initially all inputs and outputs are unmatched:
Iteration step 1: Each unmatched input requests all unmatched outputs for which it has queued packets.
Iteration step 2: Each output grants one of the requesting inputs, if any.
Iteration step 3: Each input which has received at least one grant accepts one.

The three iteration steps are repeated until the desired number of iterations has been reached.

For that purpose, each input selector IS maintains a status register, called pointer, that keeps track of which output it has most recently successfully requested (if the algorithm is two-phase the pointer is a request pointer) or accepted (if the algorithm is three-phase the pointer is an accept pointer). The position of this pointer, together with the information of the occupancy of the virtual output queue, determines which output will be requested (accepted) in the current time slot. Each output selector also maintains a status register, called grant pointer that keeps track of the most recently successfully granted input. These pointers are updated for results of the first iteration only.

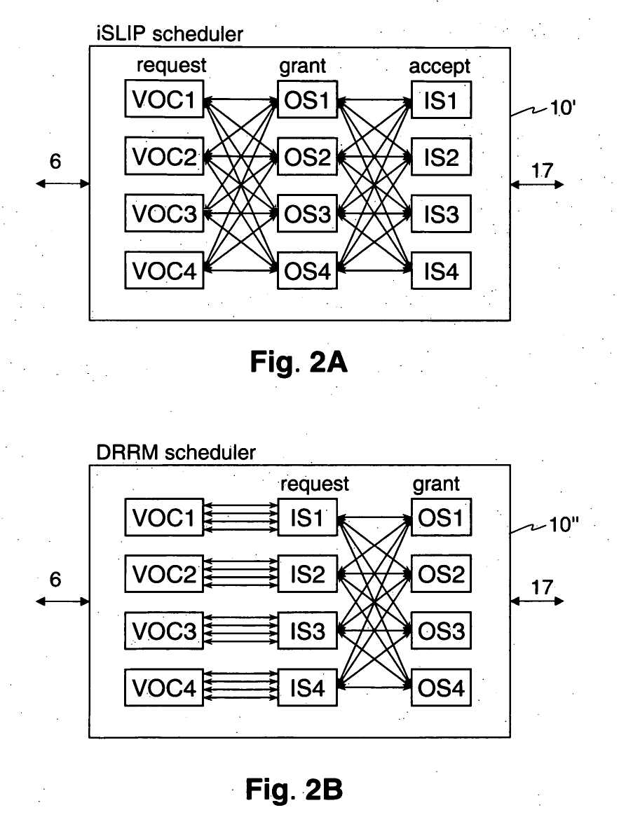

A block diagram of a first embodiment of a centralized scheduler 10′ using the iSLIP algorithm is shown in FIG. 2a. The scheduler 10′ is designed for a 4×4 crossbar switch and comprises four input selectors IS1 to IS4, four output selectors OS1 to OS4 and four virtual output queue status registers VOC1 to VOC4. Each virtual output queue status register VOC1 to VOC4 is connected via the corresponding control channel 6.1 to 6.4 to the corresponding line card 3.1 to 3.4 for determining the status of each of the virtual output queues VOQ1.1 to VOQ4.4. After the iSLIP algorithm has been executed, i.e., the matching is finished, the control signals for configuring the crossbar switch I are transmitted by the scheduler 10′ via the control lines 17 to the crossbar switch 1, and a corresponding set of grants-to-transmit is sent to the line cards 3.1 to 3.4.

A block diagram of a second embodiment of a centralized scheduler 10″ using a DRRM algorithm is shown in FIG. 2b. The scheduler 10″ is designed for a 4×4 crossbar switch and comprises four input selectors IS1 to IS4, four output selectors OS1 to OS4 and four virtual output queue status registers VOC1 to VOC4. Each virtual output queue status register VOC1 to VOC4 is connected via the corresponding control channel 6.1 to 6.4 to the corresponding line card 3.1 to 3.4 for determining the status of each of the virtual output queues VOQ1.1 to VOQ4.4. In contrast to the iSLIP scheduler 10′ as shown in FIG. 2a each virtual output queue status register VOC1 to VOC4 of the scheduler 10″ is coupled only to one input selector IS. After the DRRM algorithm has been executed, i.e., the matching is finished, the control signals for configuring the crossbar switch 1 are transmitted by the scheduler 10″ via the control lines 17 to the crossbar switch 1, and a corresponding set of grants-to-transmit is sent to the line cards 3.1 to 3.4.

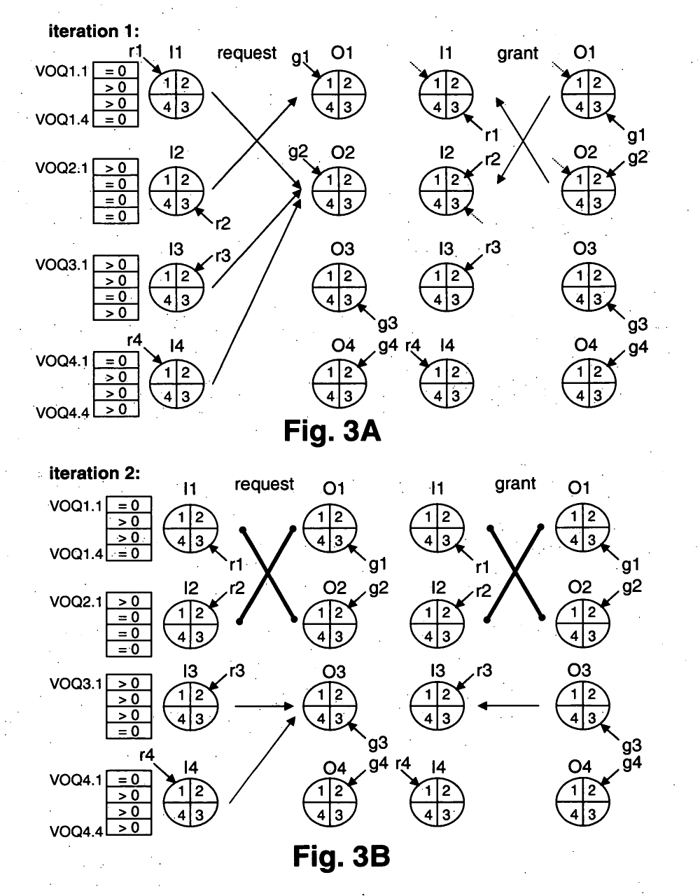

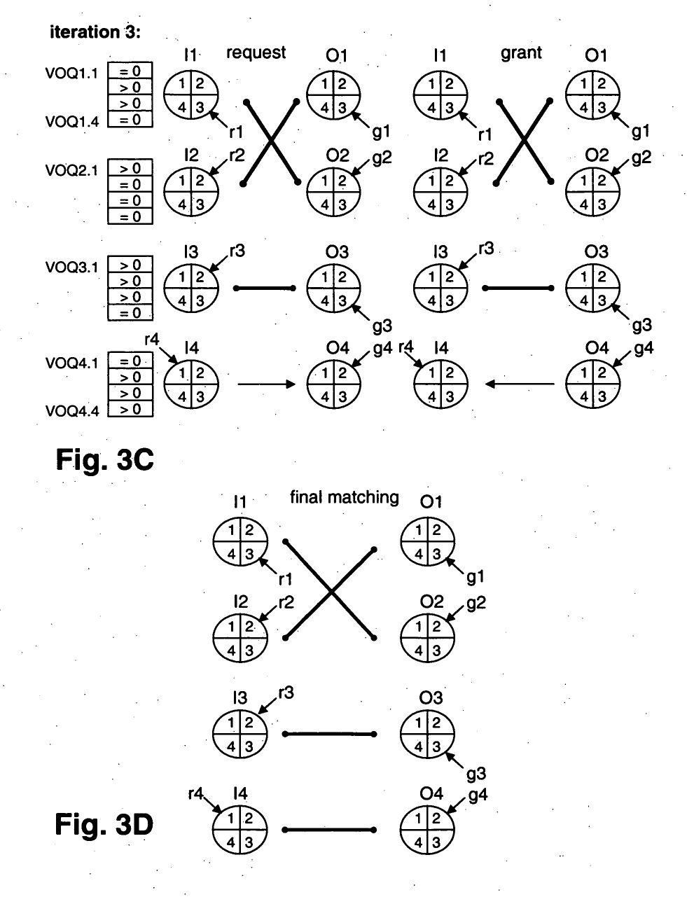

An example of how the DRRM algorithm, which is a two-phase algorithm, computes a matching on a bipartite graph having four inputs I1 to 14 and four outputs O1 to O4 is depicted in FIG. 3a to 3d. The boxes labeled VOQ1.1 to VOQ4.4 represent the status of the respective virtual output queues, where “>0” means that the VOQ is non-empty, whereas “=0” means that it is empty. DRRM employs one round-robin request pointer r1 to r4 per input I1 to 14 and one round-robin grant pointer g1 to g4 per output O1 to O4. The circles and the associated arrows represent the status of these round-robin pointers r1 to r4 and g1 to g4, with the arrow indicating the current position of the round-robin pointer. DRRM computes a matching in every time slot in a sequence of iterations. The following two iteration steps are performed in every iteration, wherein initially all inputs I and outputs O are unmatched:

Strictly speaking, an input selector IS of the scheduler 10 requests whether an output of the crossbar switch 1 is available by transmitting a request to the corresponding output selector OS. However to simplify matters in the following, the wording “an input requests an output” is used for expressing the same. Analogously, the same applies for the wording “an output grants an input”, which means that an output selector OS transmits a grant to an input selector.
Iteration step 1: Each unmatched input requests the next unmatched output for which it has queued packets starting from the current position of its request pointer r. The request pointer rp is updated to one beyond the output just requested, modulo N, if and only if the request is granted in iteration step 2 of the first iteration.
Iteration step 2: Each unmatched output grants the next requesting inputs, if any, starting from the current position of its grant pointer g. If and only if the request is granted in the first iteration, the grant pointer gp is updated to one beyond the input just granted, modulo N.

In iteration 1, depicted in FIG. 3a, applying iteration step 1 results in input I1 requests output O2 because the virtual output queue VOQ1.1, to which the request pointer r1 is actually pointing, is empty and the next cell which is queued is buffered in VOQ1.2. Input I2 requests output O1 because VOQ2.3, to which the request pointer r2 is pointing, is empty and the next cell which is queued is in VOQ2.1. Input 13 requests output O2 because VOQ3.2, to which the request pointer r3 is pointing, is non-empty. Finally, input 14 requests output O2 because the VOQ4.1, to which the request pointer r4 is pointing, is empty and the next cell which is queued is in VOQ4.2.

Applying iteration step 2 in iteration 1 results in output O1 granting input I2, because input I1, to which the grant pointer g1 actually points, did not send a request to O1, and input I2 is the first input succeeding to I1 which has send a request to O1. Output O2 grants input I1.

As denoted in iteration step 1, the request pointer r1 of input I1 is updated to one beyond the output just requested, modulo N. The output just requested is output O2 and the number N of outputs is N=4. This means that the request pointer r1 is updated to:
output #(r1)=1+2 mod 4=3\hat{=} output O3

According to iteration step 1, the request pointer r2 of input I2 is also updated to one beyond the output just requested, modulo N. The output just requested is output O1. This means that the request pointer r2 is updated to:
output #(r2)=1+1 mod 4=2\hat{=} output O2

I.e., the request pointer r1 of input I1 points now at output O3 and the request pointer r2 of input I2 points now at output O2. The previous positions to which the request and grant pointers r1 to r4 and g1 to g4 pointed are depicted with doted lines. The grant pointers g1 of output O1 and g2 of output O2 are updated to input I3 and input I2, respectively. The request pointers r3 and r4 of inputs I3 and I4, and the grant pointers g3 and g4 of the outputs O3 and O4 remain unchanged. At the end of iteration 1, two connections have been made, which are depicted by two fat lines in FIG. 3b.

In iteration 2, depicted in FIG. 3b, executing iteration steps 1and 2 on the remaining unmatched ports results in one additional connection between input I3 and output O3, which is depicted by a fat line in FIG. 3c.

Finally, in iteration 3, depicted in FIG. 3c, the final connection between input I4 and output O4 is made. The final resulting matching is depicted by flat lines in FIG. 3d, with inputs I1 to I4 being matched to output O2, O1, O3, and O4, respectively. It should be noted that in iterations 2 and 3 no request or grant pointers were updated, even when new connections were made.

If the latency that separates the input and the output selectors is larger than one time slot, the request and grant pointers can not be updated at the end of each time slot. Hence, in an implementation, where the latency is so large (e.g. in an implementation with input and output selectors on different chips, or on a single chip with long signal paths) these steps cannot be performed in the above mentioned way. A solution is to pipeline requests and grants.

The above mentioned methods can be implemented in a scheduler 10 comprising physically distributed input and output selectors in two different ways. Both are described in the following.

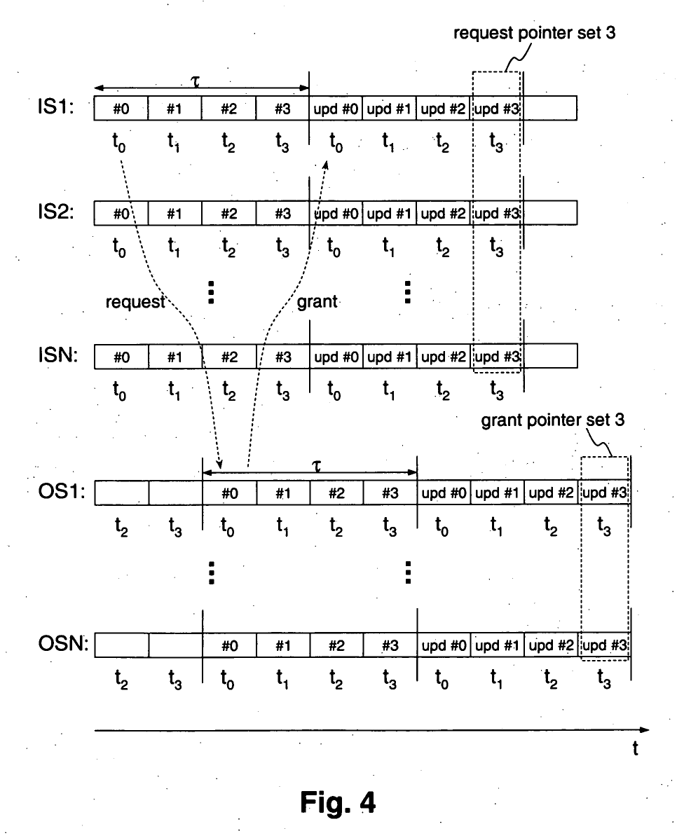

Method 1 (FIG. 4):

The time a request needs to be transmitted from an input selector IS to an output selector OS, to process the request at the output selector OS, to transmit back a grant to the input selector IS, and to process the grant at the input selector IS is called round trip time RTT. The round trip time RTT is denoted in seconds. The normalized round-trip time τ can be calculated as:

$$τ = ⌈ \frac{RTT}{T} ⌉$$

where T is the time-slot duration.

τ also specifies the number of time slots constituting the round trip time RTT. If for example, the round-trip time RTT=120 ns and the time-slot duration T=51.2 ns the normalized round-trip time τ equals τ=3. Therefore, the round trip time RTT is divided into τ=3 time slots t₀, t₁ and t₂.

Each input selector IS1 to ISN is endowed with τ pointers, called request pointers rp[0] to rp[τ−1]. This means, that in each input selector IS one request pointer rp is provided for every time slot t constituting the round trip time RTT. If for example, the scheduler 10 comprises N=2 input selectors IS1 and IS2 and the round trip time RTT is divided into τ=4 time slots t₀ to t₃, there are provided τ=4 request pointers rp[0] to rp[3] for the first input selector IS1 and τ=4 request pointers rp[0] to rp[3] for the second input selector IS2. As there are N input selectors IS1 to ISN, there are N request pointers rp[x] for the time slot t_{X}.

Each output selector OS1 to OSN is also endowed with τ pointers, called grand pointers gp[1] to gp[τ−1]. As there are N output selectors OS1 to OSN, there are also N grant pointers gp[x] for the time slot t_{X}.

The total number of pointers that are used during a certain time slot t_{X} by the input and output selectors is 2·N and is collectively referred to as a “pointer set x”. I.e, at time slot t₀ the input selectors IS1 to ISN use N request pointers rp[0] belonging to the pointer set 0. Then at each subsequent time slot a new set of request pointers rp is used. In general this means that at time slot tₖ, pointer set k is used, where k ε {0 . . . τ−1}. At every time slot, the output selectors OS1 to OSN use a pointer set whose number is the same used by input selectors IS1 to ISN to issue requests. If the input selectors IS1 to ISN have used pointer set k to issue requests, the output selectors OS1 to OSN will use pointer set k to issue grants in response to these requests.

The grant pointers g, also called output pointers, can be updated immediately, according to the rules of the algorithm employed. The request pointers r, also called input pointers, belonging to a certain pointer set, on the contrary, are updated when the grants issued with the corresponding pointer set are received at the input selector.

### EXAMPLE

At time slot to the input selectors IS1 to ISN use pointer set 0. At time slot t_{τ/2} the output selectors OS1 to OSN receive requests issued using pointer set 0, hence the output selectors OS1 to OSN issue grants using also pointer set 0. At the end of time slot t_{τ-1}, grants issued using pointer set 0 are received at the input selectors, hence input pointer set 0 can be updated. At time slot t_{τ}, which is the first time slot after expiration of the entire round trip time RTT, the (updated) pointer set 0 can be used to issue new requests.

At time slot t₁ the input selectors IS1 to ISN use pointer set 1, requests of pointer set 1 are received at the output selectors OS1 to OSN at time slot t_{τ/2+1}, and so on.

Each input pointer set and each output pointer set is strictly updated according to the policy specified by the algorithm. Hence, the pointer sets, which evolve independently from each other, will finally desynchronize and performance as well as fairness is guaranteed. For this solution τ registers at each selector (forming the pointers), a multiplexer and a counter to choose between the registers is used. The maximum speed at which selectors operate is limited by the number of input lines; having to switch between registers before operating the selection does not constitute a significant overhead.

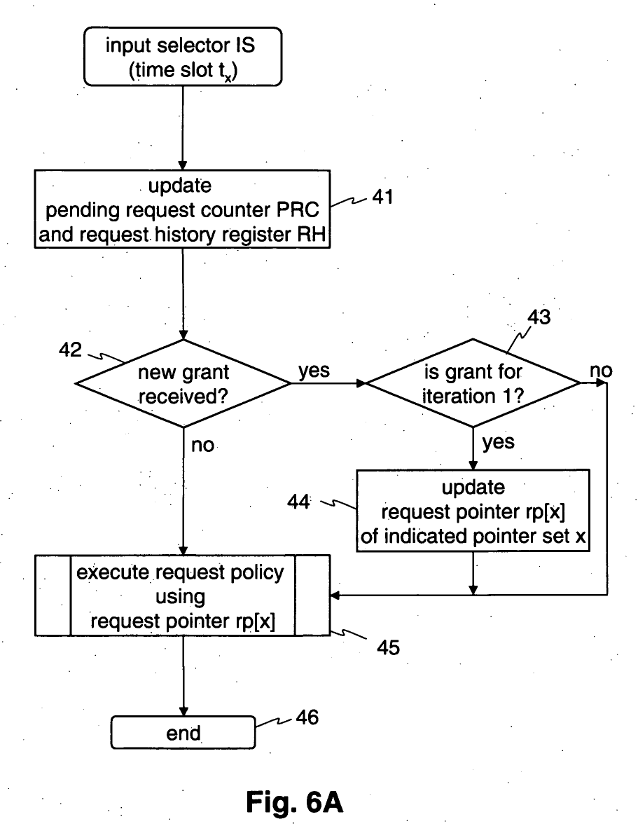

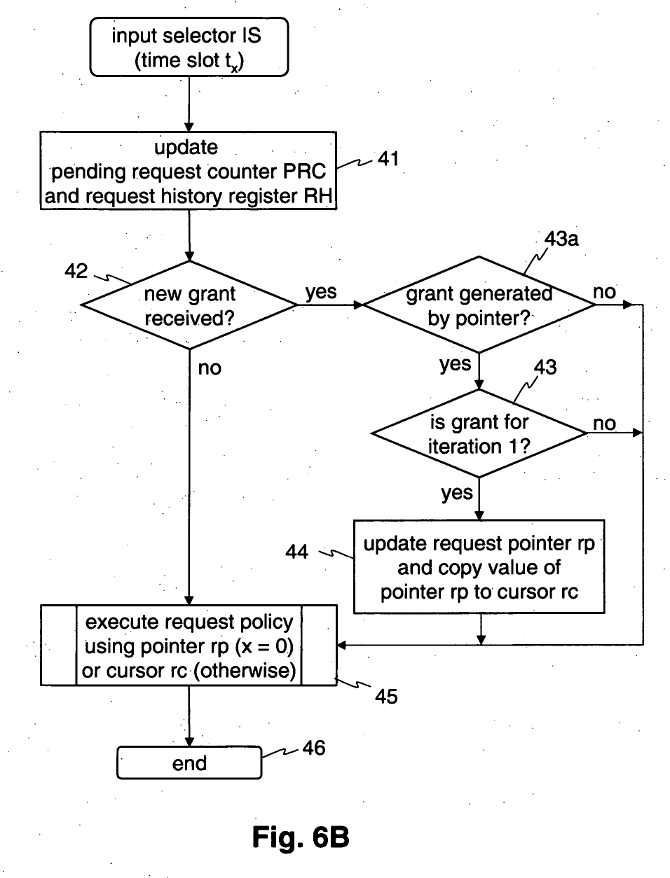

FIG. 6a depicts a flow diagram of the operation of an input selector IS in any given time slot t_{X}. The method according to the flow diagram may run on each of the input selectors IS1 to ISN.

If the input selector receives a new grant (step 42) and if this new grant was generated in the first iteration (step 43), it updates in step 44 the indicated request pointer rp to one position beyond the granted output, modulo N. To this end, the grant information comprises an indication of the iteration number as well as of the request pointer rp to update, which is equal to the request pointer rp used to issue the request in response to which this grant was issued. This indication is used as an index in the array of request pointers rp[1 . . . τ] maintained by the input selector IS.

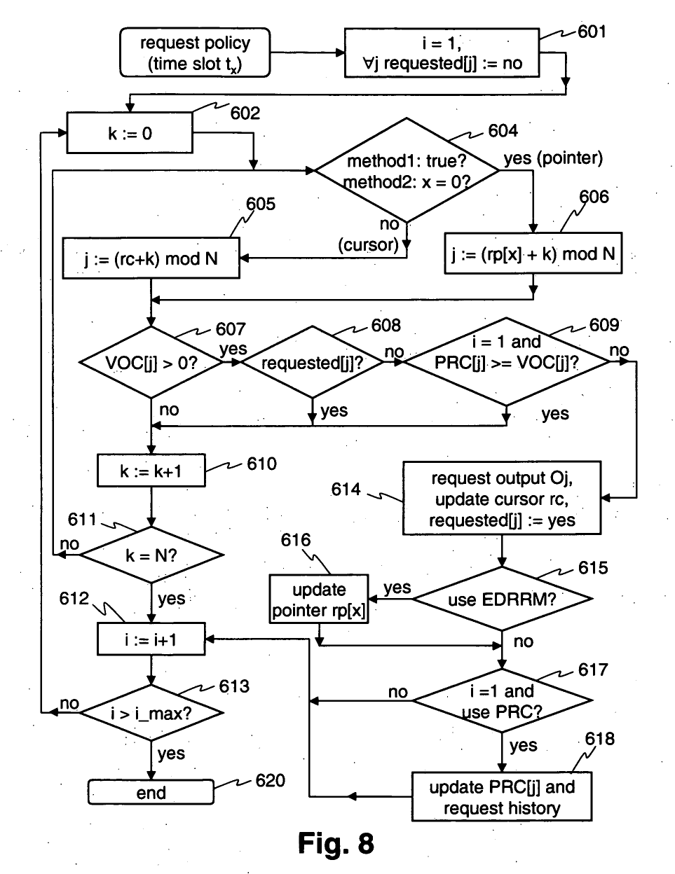

In every time slot, the input selector IS executes the request policy (step 45) to select one output O to request for every iteration. In the current time slot t_{X}, this policy will use the request pointer rp[x] with index x corresponding to t_{X} exclusively. The request policy is further detailed in FIG. 8.

When the request policy has been completed the process is done (step 46).

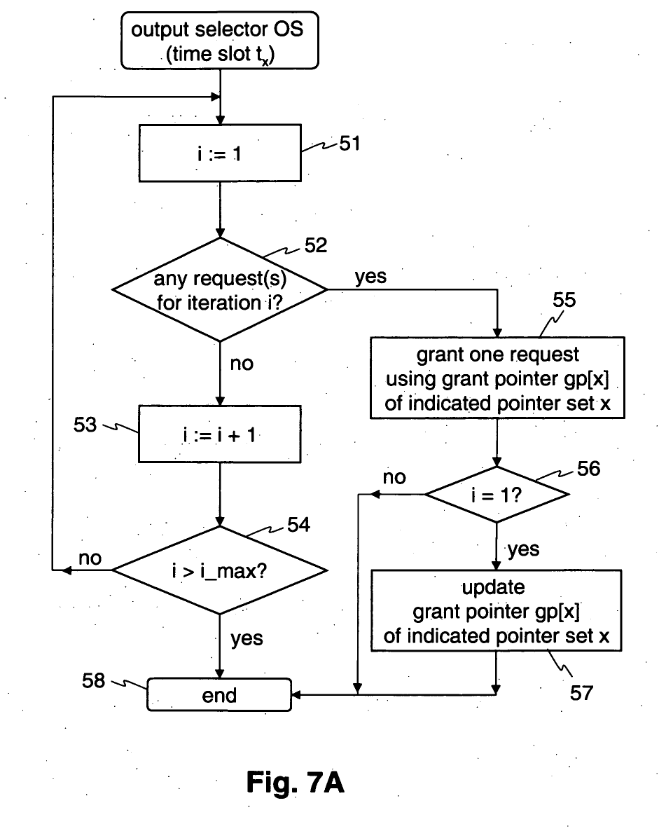

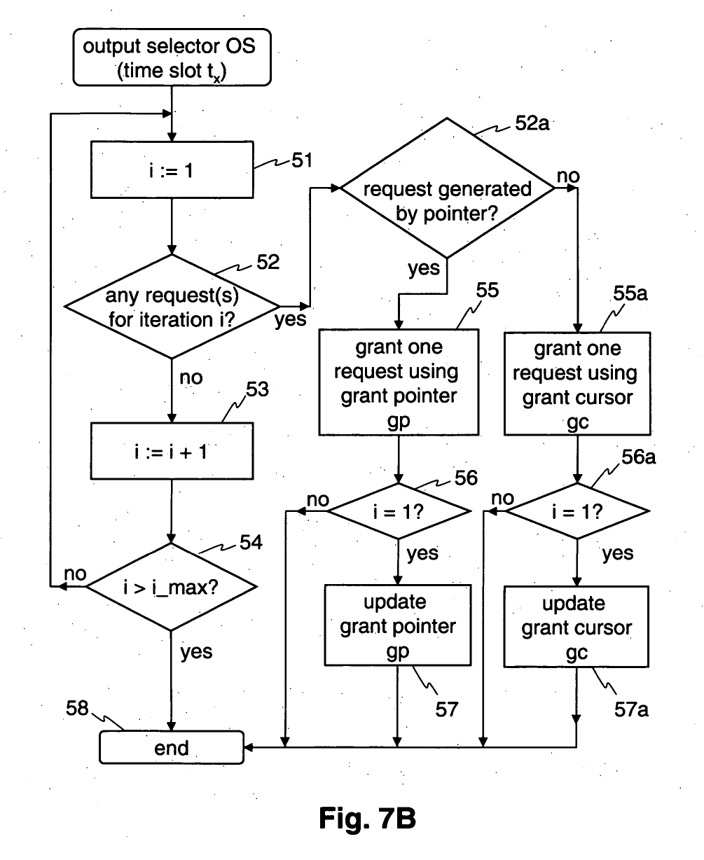

FIG. 7a depicts a flow diagram of the operation of an output selector OS in a given time slot t_{X}. The method according to the flow diagram may run on each of the output selectors OS1 to OSN. It consists of a loop (steps 51-54) over the iterations from i=1 to i=i_max, where i_max is the maximum number of iterations to be performed per time slot as before. After the index i is set to 1 (step 51) it is checked in step 52 whether there are any requests for the current iteration i. If not, the loop proceeds with the next iteration (steps 53 and 54). If there are one or more requests, the output selector OS chooses one of the requests to grant according to the iteration step 2 of the DRRM algorithm (step 55 in FIG. 7a) and, if the grant was generated in the first iteration (step 56), updates the grant pointer gp of the set indicated (step 57). To this end, the requests comprise an identification of the iteration number as well as of the request pointer set used to issue the request, which is used as an index into the grant pointer set of the output selector OS. This index is also included in the grant when it is issued. Once a request is granted, the output O is matched and does not take part in subsequent iterations of the matching process, hence the process ends (step 58).

In FIG. 8 a flow diagram of the operation of the request policy in a given time slot t_{X} is depicted. The request policy is a subroutine of the method running on the input selector IS and labeled in FIG. 4 with the reference sign 45.

The flow diagram shown in FIG. 8 covers operation with pointers only as well as with cursors and pointers.

In this diagram, N represents the number of ports of the crossbar switch, i represents the current iteration number, i_max the maximum number of iterations, x the pointer set index, k the output offset, VOC[j] the virtual output queue status corresponding to output Oj, rp[x] the request pointer with index x, and PRC[j] the pending request counter corresponding to output Oj.

First, in the initialization step 601 of the request policy the iteration number i is set to 1, the pointer set uses index x, wherein x is also the index of time slot t_{X}. I.e., pointer set x is related to time slot t_{X} and time slot t_{X} is cyclic numbered (see for example FIG. 4). All the flags requested[j] are set to no.

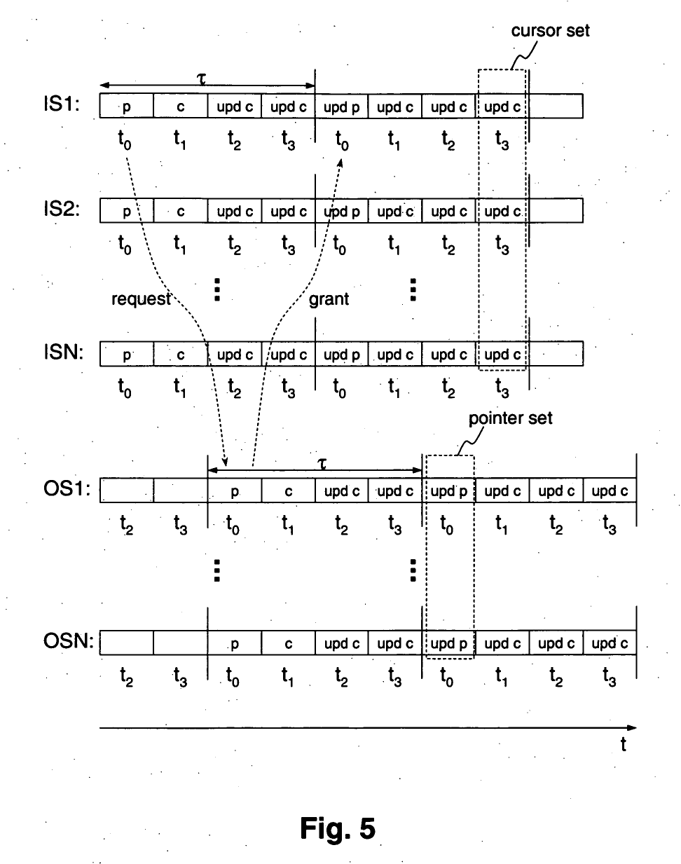

Method 2 (FIG. 5): Pointers and Cursors

In the first method the number of registers used at each selector is proportional to the number of time slots τ. If one emphasizes that less registers are used one can implement the second method.

The method employs two registers per selector, regardless of the number of time slots τ. One register contains a pointer and the other a so called cursor. This leads to a first set of pointers, simply called “pointers”, and a second set of pointers, called “cursors”. The pointers and cursors are used in different time slots and updated in different ways.

FIG. 6b depicts a flow diagram of the operation of an input selector IS in any given time slot t_{X} according to method 2. The method according to the flow diagram may run on each of the input selectors IS1 to ISN. Its operation is largely identical to that of method 1, as described above (FIG. 6a), with the following differences.

In a determined time slot t_{X}, each input selector IS uses the following policy to determine which output to request:

In step 45 (FIG. 6b), if x equals zero, then the input selector IS uses the request pointer rp (see step 6O4 in FIG. 8). Otherwise the input selector IS uses the request cursor rc (step 605). If a request is generated, in step 614 (FIG. 8) the cursor rc is moved to one position after the selected output (mod N).

When, at the end of every time slot, grants are received (FIG. 6b, step 42), the following actions are taken at the input selectors IS.

If the received grants were produced using pointers (FIG. 6b, step 43a) the request pointers rp are updated according to the received grants and the values of the request pointers rp are copied to the request cursors rc (FIG. 6b, step 44). Otherwise, i.e., if the received grants correspond to requests issued using cursors, nothing is done.

FIG. 7b depicts a flow diagram of the operation of an output selector OS in a given time slot t_{X} according to method 2 The method according to the flow diagram may run on each of the output selectors OS1 to OSN. Its operation is largely identical to that of method 1, as described above (FIG. 7a), with the following differences.

The output selectors OS operate according to the following policy:

If the received requests were produced by using pointers (FIG. 7b , step 52a) the grants are issued using grant pointers gp and afterwards the pointers are updated (FIG. 7b, steps 55, 56, 57). Otherwise (the received requests were produced by using cursors) the grants are issued using grant cursors gc and afterwards the cursors are updated (FIG. 7b, steps 55a, 56a, 57a).

In order to know if the requests (grants) received were produced using pointers or counters, the requests (grants) comprise an identification (e.g., a bit), or, alternatively, a counter can be used at each output (input), as it is known that first of each group of RTT requests (grants) are issued using pointers, the remaining using cursors.

The idea behind this solution is that one can have a “slow”, but strict scheduling algorithm using pointers, overlapped with a simple round-robin algorithm using cursors. Every request-grant cycle of the “slow” scheduling algorithm takes τ time slots. However, the pointers are strictly updated according to the algorithm rules, hence they will eventually desynchronize and they guarantee fairness. Once desynchronization of the pointers has been achieved, the copy operation propagates it to cursors. As a matter of fact, the cursors start from the positions of the pointers (which are desynchronized, hence point to different outputs) and afterwards, being all moved by one position at every time slot, will remain desynchronized.

If not all virtual output queues VOQ1.1-VOQN.N are non-empty, the round-robin policy that is used to update cursors is not optimal, as it might lead cursors to synchronize again. However, as soon as a request-grant cycle using pointers is completed, the situation will be corrected by aligning cursors to pointers, and desynchronization is regained.

Although this solution guarantees 100% throughput when the switch is uniformly loaded at 100%, performance under intermediate loads decreases as the round trip time RTT increases, because cursors are updated less frequently and “sub-optimal” cursor positioning, caused by empty VOQs, take longer to be corrected. If the round trip time RTT is particularly long, it is possible to increase the number of pointers and align cursors more frequently. For instance, if three pointers are used instead of two, cursors can be aligned every τ/2 time slots. As an extreme case, one may have τ sets of pointers, and one falls back to the first method described above.

In the following an enhancement of the request selection policy is described, with which excess requests can be reduced.

Every input selector IS keeps track of the number of pending requests per output O using a set of N pending request counters PRC[1 . . . N]. The pending request counter PRC[j], where j ε {1 . . . N}, is incremented whenever a request for output Oj is issued in the first iteration. For every increment operation there is a corresponding decrement operation after τ time slots have elapsed since the increment operation. In a preferred embodiment, this is implemented by means of a request history shift register RH with T entries, labeled RH[1 . . . τ], where the register position RH[t] indicates the output O that was requested t time slots ago. At the end of every time slot, the request history register RH is shifted by one position, making room for one new entry and removing the oldest entry. The pending request counter PRC corresponding to the output O indicated by this oldest entry, if any, is decremented. The input selector IS records a new entry in the register RH at register position RH[1] when it issues a new request. Step 41 represents the update operation for the pending request counter PRC and the request history register RH as described above.

In an alternative embodiment, the functionality of the request history could be replaced by in response to the requests submitted in the first iteration, where every acknowledgment indicates the previously requested port. Upon receipt of such an acknowledgment the pending request counter PRC corresponding to the indicated port is decremented.

When an input selector IS submits a request, it has to wait τ time slots to know whether the request has been granted or not. In the meanwhile the input selector IS cannot update the virtual output queue status information and does not know whether it is worth submitting more requests for the same virtual output queue VOQ or try a different one. If more requests are submitted for a virtual output queue VOQ than it has packets, grants can be wasted. This phenomenon is particularly significant and harmful when the switch is lightly loaded and most virtual output queues are empty or have few packets enqueued. This issue can be addressed by keeping N pending request counters PRC[1 . . . N] at every input selector IS, together with N virtual output queue counters VOC[1 . . . N], that track the occupancy of the virtual output queues VOQ1.1-VOQN.N. When a request for a virtual output queue VOQx is submitted, the corresponding pending request counter PRCx is incremented (step 618). When the (positive or negative) response to a request is known (a time slots after issuance), the pending request counter PRCx is decremented. The virtual output queue counter VOCx is only decremented on positive grants. The request policy is as follows: Any output Oj, for which the virtual output queue is empty (i.e., VOC[j]=0), is not requested in any iteration (step 607). Furthermore, the input selector IS will not request in the first iteration any output Oj for which the pending request counter PRC[j]>=VOC[j] (step 609). The outputs for which PRC[j]>=VOC[j] are only eligible for a request in iterations 2 and on. The pending request counter PRC[j] is only updated for requests and grants corresponding to the first iteration (steps 617 and 618). These are referred to as primary requests and primary grants vs. secondary ones for subsequent iterations. Grants and requests carry an iteration number identifier to make this distinction.

This enhancement of the request policy is not strictly necessary for any of the two solutions described above. It can be beneficial to both when RTT is large and the load low, or when the traffic is heavily unbalanced.

In the following an enhancement of the request selection policy is described, with which the request diversity can be increased.

This enhancement of the request policy is specifically directed at improving the efficiency of performing multiple iterations. As pointed out before, when the latency between the input and the output selectors is large, the requests submitted for iterations following the first cannot take into account the results of previous iterations. However, one knows that it is useless for an input selector IS to request the same output in multiple iterations. As a matter of fact, if a request is not granted during the first iteration, it means that the output has granted another input, hence there is no point in requesting it again in following iterations. Therefore, the usage of N 1-bit flags at every input selector IS is proposed, to keep track of which output is requested in each iteration and to avoid requesting it again in subsequent ones. These flags are called output requested flags ORF and are reset at the beginning of every time slot (step 601). The output requested flag ORF[j] is set when the input selector IS requests output Oj (step 614). The filtering is performed as follows (step 608). Any output Oj for which the output requested flag ORFj is set, is not eligible for a request in any iteration.

Another enhancement to improve request diversity is to also employ a cursor in conjunction with method 1. As the cursor is updated after every request (step 614), one can achieve optimal request diversity by using the cursor value instead of the pointer value in iterations 2 and on. This enhancement is reflected in step 604.

To enhance the performance the request policy can execute an EDRRM (Enhanced Dual Round Robin Matching) which is a variant of the basic DRRM algorithm with a modification in the request step (iteration step 1); otherwise EDRRM is identical with DRRM. The request step 1 of EDRRM operates as follows:

Each unmatched input requests the next unmatched output for which it has queued packets starting from the current position of its request pointer r. In the first iteration, the request pointer rp is updated to the output just selected. The request pointer rp is further updated to one beyond the output just requested, modulo N, if and only if the request output is granted in step 2 of the first iteration.

As shown in the flow diagram of FIG. 8, the use of EDRRM is optional. In step 615 it is determined whether EDRRM is used. If EDRRM is used, the step 616 is processed, i.e. the pointer is updated as just described above. Otherwise step 616 is skipped.

The use of the pending request counters PRC is also is optional. In step 617 it is determined whether the pending request counters PRC are used. If they are used, step 618 is executed, i.e. the pending request counter PRC[j] and the request history register RH are updated. Otherwise step 618 is skipped and step 612 is processed.

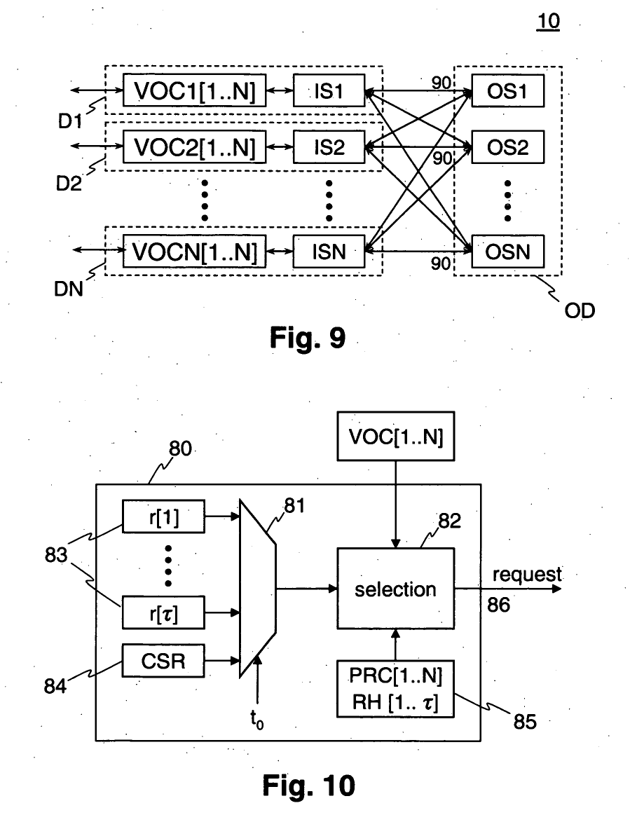

FIG. 9 depicts a distributed embodiment of the centralized scheduler 10. Input selector IS1 is combined with the virtual output queue status register VOC1 on one chip D1, and input selector ISN is combined with the virtual output queue status register VOCN on a further chip DN. This means, that each input selector IS is combined with one virtual output queue status register VOC on a separate chip. The output selectors OS1 to OSN however are combined in a single physical device OD, i.e. a single chip, having input terminals or pins 90. In different embodiments, multiple input selectors IS or multiple output selectors OS can be grouped on a single chip. There are two main reasons for this arrangement.

First, the output selectors OS1 to OSN should be able to share information about which inputs have been matched in previous iterations, otherwise they are not able to properly mask requests in subsequent iterations, which could lead to violations of the required one-to-one matching property. If there is only one iteration to be performed in every time slot, this argument does not hold.

The second reason is, that this arrangement allows a more efficient interconnection pattern between the input selectors IS1-ISN and the output selectors OS1-OSN across device or chip boundaries, requiring N connections of O(log(N)) bits wide per input instead of N2 connections of O(1) bits, where O( ) is an ordinal number. This results in a lower aggregate pin-out complexity.

Depending on the capacity of the device used, several of the devices D1 to DN may be also integrated in a single device.

FIG. 10 depicts an embodiment of the request-generating part 80 of one of the input selectors IS1 to ISN. It comprises an array of request pointers rp[1 . . . τ] stored in registers 83, the cursor rc stored in a register 84, a selector 81, which can be a multiplexer, a combinational selection logic unit 82, and a pending request counter array PRC[1 . . . N] along with a request history shift register RH[1 . . . τ], which are stored in registers 85. The request can be tapped at terminal or pin 86.

The methods described above are related to the use of the DRRM matching algorithm, but they can also be applied to other iterative pointer-based matching algorithms.

Having illustrated and described a preferred embodiment for a novel method and apparatus for, it is noted that variations and modifications in the method and the apparatus can be made without departing from the spirit of the invention or the scope of the appended claims.

1. Method for scheduling interconnections in an interconnecting fabric, comprising the following steps:
in a determined time slot input selectors generate requests using a request pointer set, which is related to the determined time slot,
the requests are transmitted to output selectors,
the output selectors generate grants using a grant pointer set, which is also related to the determined time slot,
the grants are transmitted to the input selectors,
the input selectors update the request pointer set,
these steps are repeated, wherein for a further time slot a further request and grant pointer set are used, which are related to the further time slot.

2. Method according to claim 1,
wherein the round trip time, which is the time period for a request-grant cycle, is divided into a determined number time slots, and
wherein a separate pointer set is related to every time slot.

3. Method according to claim 2,
wherein the pointer set is updated at the end of the round trip time.

4. Method for scheduling interconnections in an interconnecting fabric, comprising the following steps:
in a first time slot input selectors generate requests for interconnections using a first request pointer set, which is updated at the end of the round trip time for a request-grant cycle,
in a further time slot input selectors generate requests for interconnections using a second request pointer set, which is updated before a succeeding time slot.

5. Method according to claim 4,
wherein the output selectors issue grants using a first grant pointer set, if the received requests were generated using the first request pointer set, and
wherein the output selectors issue grants using a second grant pointer set, if the received requests were generated using the second request pointer set.

6. Method according to claim 5,
wherein the output selectors update the first grant pointer set before they receive the next requests, and
wherein the output selectors update the second grant pointer set before they receive the next requests.

7. Method according to claim 1,
wherein requests and grants comprise an indicator of the pointer set used to generate the requests or grants.

8. Method according to claim 1,
comprising the following steps:
when a request is transmitted a pending request counter is incremented,
when a response to the request is received at the input selector the pending request counter is decremented.

9. Method according to claim 4,
wherein a virtual output queue counter, indicating the number of requests deriving from a determined virtual output queue, is decremented if the input selector receives a grant.

10. Method according to claim 9,
wherein an output is not requested, if the value of the pending request counter related to that output is equal to or exceeds the value of the virtual output queue counter related to that output.

11. Method according to claim 1,
wherein an output requested flag for a determined output selector is set, if the input selector has transmitted a request to the output selector in the current time slot, and
if the output requested flag is set, the output selector is not requested again in a subsequent iteration in the current time slot.

12. Input selector device for scheduling interconnections in an interconnecting fabric, comprising:
registers for request pointers,
a selection unit, which is operable to select one of the registers and generate requests for interconnections, and
an output terminal which is coupled to the selection unit and at which a signal representing the request can be tapped.

13. System for scheduling interconnections in an interconnecting fabric according to claim 12,
comprising one or more input selector devices and an output selector device, which is connected to the input selector devices, and
wherein the input selector devices and the output selector device are operable to control a crossbar switch.

14. Output selector device for scheduling interconnections in an interconnecting fabric, comprising:
output selectors, wherein each output selector comprises registers for grant pointers,
input terminals operable to receive requests from an input selector device, and
output terminals operable to transmit grants to the selector device.

15. System for scheduling interconnections in an interconnecting fabric according to claim 13,
comprising one or more input selector devices and an output selector device, which is connected to the input selector devices, and
wherein the input selector devices and the output selector device are operable to control a crossbar switch.
